(19) United States
(12) Patent Application Publication
(10) Pub. No.: US 2025/0066650 A1
(43) Pub. Date: Feb. 27, 2025

(54) Epoxy Resin Adhesives

(71) Applicant: Gurit (UK) Ltd., Newport (GB)

(72) Inventors: Frances Sharp, Newport (GB); Tony Bonser, Newport (GB)

(21) Appl. No.: 18/710,446

(22) PCT Filed: Nov. 18, 2022
(86) PCT No.: PCT/EP2022/082465

§ 371 Date: May 15, 2024

(30) Foreign Application Priority Data
Nov. 19, 2021 (GB) 2116700.2

(51) Int. Cl. C09J 163/00; C08G 59/02; C08G 59/22; C08G 59/50; C08G 59/56; C09J 5/00

(52) U.S. Cl. CPC C09J 163/00; C08G 59/022; C08G 59/22; C08G 59/5033; C08G 59/504; C08G 59/56; C09J 5/00; C08G 2170/00

(57) ABSTRACT

A curable epoxy resin adhesive, comprising an epoxy resin component and a curing agent component in a separated form, the epoxy resin component comprises at least one epoxide-containing resin, the curing agent component comprises: (i) a first amine curing agent comprising a polyoxyalkylene diamine having the formula NH₂—(Z)x-R—NH₂ where R is an aliphatic or cycloaliphatic constituent, unsubstituted or substituted with at least one functional group, Z is an oxyalkylene moiety and x has a value of greater than 1 and less than 10; and (ii) a second amine curing agent having the formula NH₂—R¹—NH₂ where R¹ is any aromatic constituent, unsubstituted or substituted with at least one functional group, wherein the curing agent component comprises from greater than 50 to up to 85 wt % of the first amine curing agent and from 15 to less than 50 wt % of the second amine curing agent, each based on the total weight of the first and second amine curing agents.

### FIELD OF THE INVENTION

The present invention relates to an epoxy resin adhesive, and to the manufacture and use of such an epoxy resin adhesive. The present invention in particular relates to a two-component epoxy resin adhesive comprising a resin component comprising epoxy resin and a hardener component comprising a curing agent system for curing the epoxy resin after the resin component and the hardener component have been mixed together. The present invention has particular application for use as an adhesive for bonding together large structural parts, for example structural elements of wind turbine blades during manufacture of the wind turbine blade, or parts of marine vessels or civil engineering structures, for which a long working time at ambient temperature for the uncured mixture of the resin and hardener components is desired, in combination with a fast curing time at an elevated curing temperature.

### BACKGROUND

It is well known to use epoxy resin adhesives, particularly in combination with fibre-reinforced resin composite materials for the manufacture of structural parts in a variety of industrial sectors. For example, epoxy resin adhesives are used for adhesively bonding together large structural parts, for example structural elements of wind turbine blades during manufacture of the wind turbine blade, for which a long working time at ambient temperature for the uncured mixture of the resin and hardener components is desired, in combination with a fast curing time at an elevated curing temperature.

It is well known to use a group of compounds referred to as amines, which are characterised by the functional group —NHₓ, to cure epoxy resins. Most commercial amines are liquids and therefore suitable for low temperature curing, two component thermoset systems comprising a first resin component and a second curing agent component. The reactivity of an epoxy resin-curing agent system can be adjusted either through epoxy resin type but more commonly due to the type of amine compound used. Differences in amine functionality, type of amine, for example primary, secondary or tertiary, as well as the level of steric hindrance and delocalisation of the amine compound, allow the formulator to produce a range of different reactivity resin systems.

It is common practice to blend different amines together to optimise and balance a variety of different properties when formulating an epoxy resin adhesive. For example, different amines may be blended to adjust the reactivity, the “mix ratio”, i.e. the ratio of resin:amine to provide a cured system, and the thermal and mechanical performance. However, in general, regardless of the blend of amines, the use of more reactive amines results in short working times and short cure times. Likewise, the use of lower reactive amines can result in long working times and long cure times.

Many formulations for two-component amine-cured epoxy adhesives currently exist on the market. Such two-component amine-cured epoxy adhesives comprise a resin component comprising epoxy resin and a hardener component comprising an amine curing agent system for curing the epoxy resin after the resin component and the hardener component have been mixed together. These two-component amine-cured epoxy adhesives are the primary choice of those skilled in the art for structural bonding of wind turbine blade parts or elements during manufacture.

These two-component amine-cured epoxy adhesives are typically applied for use in bonding wind turbine blades as follows:
1. The blade producer purchases a container of an epoxy adhesive resin and a separate container of amine “hardener” for the adhesive resin.
2. These two components are mixed together at ambient temperature, often using a semi-automated mixing machine.
3. Once mixed, the amine component starts to react with the epoxy component and the adhesive starts to cure.
4. The blade producer needs to apply the mixed adhesive to the blade shells and/or spars, these elements being composed of composite material. It is important that the adhesive does not cure during this stage and remains sufficiently fluid to allow uniform application of the adhesive over the entire area to be bonded, prior to closure of the bonded joint.
5. Once the adhesive is applied, the second half of the blade shell is brought into contact to form the bond.
6. The blade assembly is then heated to complete the cure.
7. Upon cure, the blade is cooled, refinished and can enter service life.

A corresponding sequence of steps may be used to make other components or products, for example in the marine or civil engineering industries.

Two time parameters are particularly important for this process, namely the working time and the curing time. These time parameters relate to the curing or reactivity characteristics of the adhesive resin system. The working time and the curing time are two primary parameters that can be used to characterise the curing process in relation to the intended application.

The term “working time” is defined herein as to the maximum time period that the adhesive remains fluid enough to be applicable to the substrate to be bonded. Long working times are beneficial as they allow more time to apply the adhesive, which is particularly important for large structures or when there are limited mixing machines and/or operators available to apply the adhesive. The working time is a function of working temperature. Typically adhesives are applied at ambient workshop temperatures, i.e. within a typical temperature range of from 20 to 30° C., for example 25° C.; however, some blade producers may apply the adhesive at warmer temperatures, for example up to 50° C., a typical warmer working temperature being 40° C. In this specification, the term “ambient temperature” means a temperature within the range of from 20 to 30° C.

The “cure time” is defined herein as the time period, beginning at the time after the adhesive has been applied and the bond joint has been subsequently closed, during which the adhesive cures and reaches full mechanical strength to allow the adhesive-bonded product to enter service. The cure time is a function of temperature and may be quoted at different temperatures. However for most wind blade applications, the cure takes place at elevated temperatures so as to ensure both an economically short cure time and the generation of maximum mechanical and thermal properties in the resultant adhesive-bonded product.

Accordingly, both working time and cure time are a function of temperature.

FIG. 1a is a graph which schematically shows the relationship between temperature and time during both working and subsequent curing for a typical known curable epoxy resin adhesive. The working time at low ambient temperature, such as 20° C. as shown in the graph, is in this example about 100 minutes. At the end of the working time the temperature rapidly increases as a result of applying an external heat source to initiate exothermic curing of the epoxy resin, for example by heating to an applied temperature of 70° C. as also shown in the graph. Thereafter the resin cures during a cure time period. In this example the cure time period is about 375 minutes. It would be desirable to increase the working time and/or decrease the cure time, without compromising, and preferably increasing, the mechanical properties of the cured resin.

Most amine-cured epoxy systems are formulated to adopt a curing profile close to a first order kinetics model, whereby increasing the temperature reduces both the working time and the cure time.

Therefore known two-component amine-cured epoxy adhesives suffer from the problem that the adhesive composition is formulated with a working time that is insufficiently short when a long cure time is required, or alternatively when a long working time is required, the cure time is excessively long cure.

For example, the Applicant currently manufactures and sells a high Tg structural epoxy adhesive which can be used with three alternative hardeners, called “Fast”, “Slow” or “Extra-slow” hardeners. The Fast hardener has a pot life (500 g, mixed in air) of 16 minutes and a clamp time (to 2 kN cleavage strength) of 3 hours 50 minutes, each at an ambient temperature of 20° C. Corresponding times for the Slow hardener are a working time of 45 minutes and a cure time of 17 hours 40 minutes, and for the Extra-slow hardener a working time of 2 hours 20 minutes and a cure time of 24 hours. The pot life is a specific parameter used in the art to describe how a particular mass of the resin system behaves in use and is indicative of a working time. However, the actual working time within which a resin is sufficiently liquid to be spreadable is generally longer than such a pot life. Similarly, the clamp time to provide a specific bond strength, which strength may increase further upon further curing, is indicative of a cure time, but the cure time can also be measured indirectly by measuring the increase of Tg of the cured resin.

It may be seen that for this commercial adhesive that although different hardeners can be selected to achieve desired working or cure times, for example a longer working time or a faster cure time, for each hardener a longer working time is associated with a longer cure time, and a faster cure time is associated with a shorter working time. The option of a short cure time and a long working time is not available to achieve the desired properties in the cured adhesive resin.

There is therefore a need in the art for an amine-cured epoxy resin adhesive that can provide the combination of a long working time and a short cure time. However as these two parameters are effectively mutually inclusive using known epoxy resin and amine hardener systems, this technical advantage is not possible with traditional or currently available amine-cured epoxy resin adhesives.

There is also a need in the art for an amine-cured epoxy resin adhesive that can provide the combination of a long working time and a short cure time, even when the working time is carried out at higher working temperatures, for example 40° C., than a typical ambient working temperature within the range of from 20 to 30° C.

### SUMMARY OF THE INVENTION

The present invention aims at least partially to overcome this technical problem with known amine-cured epoxy resin adhesives.

The present invention aims to provide an epoxy resin adhesive which can achieve the technical advantage of the combination of long, or increased, working time and short, or reduced, cure time, for example as compared to known amine-cured epoxy resin adhesives, in order to overcome this technical problem with known amine-cured epoxy resin adhesives.

The present invention also aims to provide an epoxy resin adhesive which can maximise working time yet reduce cure time.

Accordingly, in a first aspect, the present invention provides a curable epoxy resin adhesive, the adhesive comprising an epoxy resin component and a curing agent component, wherein the epoxy resin component and the curing agent component are in a separated form, and wherein providing a mixture of the epoxy resin component and the curing agent component at a curing temperature of the adhesive causes curing of the epoxy resin component by the curing agent component, wherein the epoxy resin component comprises at least one epoxide-containing resin, and wherein the curing agent component comprises: (i) a first amine curing agent, wherein the first amine curing agent comprises a polyoxyalkylene diamine having the formula NH₂—(Z)x-R—NH₂ where R is an aliphatic or cycloaliphatic constituent, which is either unsubstituted or substituted with at least one functional group, Z is an oxyalkylene moiety and x has a value of greater than 1 and less than 10; and (ii) a second amine curing agent having the formula NH₂—R¹—NH₂ where R¹ is any aromatic constituent, which is either unsubstituted or substituted with at least one functional group, wherein the curing agent component comprises from greater than 50 to up to 85 wt % of the first amine curing agent and from 15 to less than 50 wt % of the second amine curing agent, each based on the total weight of the first and second amine curing agents.

In a second aspect, the present invention provides a method of manufacturing a curable epoxy resin adhesive, the method comprising the steps of
i. providing the epoxy resin component;
ii. providing the first amine curing agent;
iii. providing the second amine curing agent;
iv. mixing together the first and second amine curing agents to produce the curing agent component; and
v. providing both the epoxy resin component and the curing agent component in a separated form thereby to provide the curable epoxy resin adhesive, wherein providing a mixture of the epoxy resin component and the curing agent component at a curing temperature of the adhesive causes curing of the epoxy resin component by the curing agent component.

In a third aspect, the present invention provides a use of a curable epoxy resin adhesive for bonding together structural parts of a wind turbine blade, a marine vessel or a civil engineering structure.

Preferred features of these aspects of the present invention are defined in the respective dependent claims.

The present inventors have addressed this problem of known amine-cured epoxy resin adhesives and have found that by providing a particular mixture, or blend, of a plurality of amine curing agents, typically at least two amine curing agents, the working time of a curable epoxy resin adhesive may be extended without significantly increasing the cure time or compromising on the mechanical properties of the cured resin. The present invention provides a working time which is particularly extended by providing an “Extra slow” hardener, yet which does not significantly extend the curing time or reduce the mechanical properties of the cured resin.

The preferred embodiments of the present invention can provide an epoxy resin adhesive composition which can maximise working time yet reduce cure time as compared to some known adhesives. As a result, bonding cycle times can be reduced by up to 3 hours, without loss of working time or mechanical properties.

Without being bound by any theory, the present inventors consider that the present invention is predicated on the finding that by combining the functionality of the first curing agent, i.e. the polyoxyalkylene diamine, and the second amine curing agent, i.e. the aromatic diamine which contains at least two primary amine groups, the resultant curing system can achieve “Extra-slow” hardening at ambient, or slightly higher than ambient, temperatures to achieve long working times. Although the curing time is slightly increased, this is more than compensated by the desired increase in working time. The polyoxyalkylene diamine provides an extension in the working time whereas the aromatic diamine achieves a decrease in the curing time. In the aromatic diamine, the aromatic backbone can provide that delocalisation and steric hindrance are low and so the reactivity of the two primary amine groups of the aromatic diamine with the epoxide groups of the epoxy resin is relatively high at elevated temperatures. Therefore low relative reactivity of the two primary amine groups of the aromatic diamine with the epoxide groups of the epoxy resin is observed at ambient application temperatures; in contrast, at elevated or “post cure” temperatures, the amine curing agent is more reactive and more exothermic. Accordingly, the temperature of the epoxy resin system increases at post cure temperature which, because reactivity is a function of temperature, significantly increases the resulting reaction rate, resulting in accelerated cross linking and a faster resultant cure time. This faster cure time also achieves a high Tg and good mechanical properties in the resultant cured epoxy resin.

### BRIEF DESCRIPTION OF THE DRAWINGS

Preferred embodiments of the present invention will now be described by way of example only with reference to the accompanying drawings, in which:

FIGS. 1a and 1b are graphs which schematically show the relationship between temperature and time during both working and subsequent curing for, respectively, a known curable epoxy resin adhesive and a curable epoxy resin adhesive in accordance with an embodiment of the present invention;

FIG. 2 is a perspective view of a syringe used to test the curing properties of a modelled curable epoxy adhesive in accordance with the present invention; and

FIG. 3 is a graph which shows the relationship between temperature and time during curing at a curing temperature of about 70° C. for an example of a curable epoxy adhesive in accordance with an embodiment of the present invention, and for a comparative example of a curable epoxy adhesive not in accordance with the present invention; and

FIG. 4 is a graph which shows the relationship between temperature and time during curing at a curing temperature of about 40° C. for the example and comparative example of curable epoxy adhesives used in FIG. 3.

### DETAILED DESCRIPTION

In accordance with the present invention there is provided a curable epoxy resin adhesive.

The present invention has particular application for use as an adhesive for bonding together large structural parts, for example structural elements of wind turbine blades during manufacture of the wind turbine blade, or parts of marine vessels or civil engineering structures, for which a long working time at ambient temperature for the uncured mixture of the resin and hardener components is desired, in combination with a fast curing time at an elevated curing temperature.

Epoxy resins exhibit excellent adhesive properties and mechanical properties. Therefore the epoxy resins used in the preferred embodiments of the present invention can easily meet the adhesive bonding requirements to enable an epoxy resin adhesive layer to bond strongly to materials used in wind blade manufacture, such as a fibre-reinforced resin matrix composite material, for example an epoxy resin matrix composite reinforced with glass or carbon fibres, or a core material, for example the surface of a polymeric cellular foam (e.g. PET structural foam), balsa or honeycomb (e.g. Nomex® honeycomb) core material.

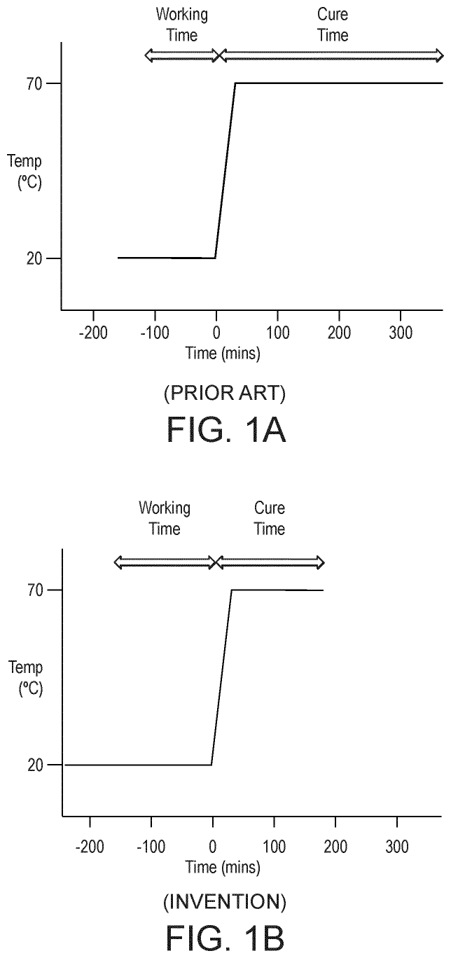

FIG. 1b, like FIG. 1a, is a graph which schematically shows the relationship between temperature and time during both working and subsequent curing for a curable epoxy resin adhesive in accordance with an illustrative example of the present invention. The working time at low ambient temperature, such as 20° C. as shown, is in this example about 150 minutes. At the end of the working time the temperature rapidly increases as a result of applying an external heat source to initiate exothermic curing of the epoxy resin, for example by heating to an applied temperature of 70° C. Thereafter the resin cures during a cure period. In this example the cure period is about 175 minutes.

As compared to the known resin of FIG. 1a, the modified epoxy resin system comprising a curing agent mixture has increased the working time and decreased the cure time, without compromising the mechanical properties of the cured resin. The longer working time has particular utility when bonding large surface areas. The shorter cure time reduces the overall curing cycle time, which can achieve cost savings both for operational production costs and for capital investment costs.

The curable epoxy resin adhesive comprises an epoxy resin component and a curing agent component. The epoxy resin component and the curing agent component are made and sold in a separated form. During use of the adhesive, a mixture of the epoxy resin component and the curing agent component is formed, as is well known in the art of thermosetting resins, with the epoxy resin component and the curing agent component being mixed at a predetermined ratio, typically a weight ratio, so that the curing agent provides the required number of reactive groups to react with the number of epoxide groups present in the amount of epoxy resin to be cured. The mixture is then usually heated to an elevated curing temperature, which causes curing of the epoxy resin component by the curing agent component, to form the cured adhesive. A typical curing temperature for a curable epoxy resin adhesive is within the range of from 50 to 100° C., for example 70° C.

The epoxy resin component comprises at least one epoxide-containing resin. The at least one epoxide-containing resin is typically selected from at least one of a bisphenol-based epoxy resin, an epoxy novolac resin, an epoxy cresol novolac resin and an epoxy phenol novolac resin, or a mixture of any two or more thereof. Epoxy resins of different epoxide functionality, and/or different epoxide equivalent weight (EEW) may be blended to achieve desired properties in both the curable resin and the cured resin, as is well known in the art. Typically, the epoxy resin component as an overall epoxy equivalent weight (EEW) of from 175 to 300 g/eq. In a preferred embodiment, the epoxy resin component comprises a diglycidyl ether bisphenol-A (DGEBA) epoxy resin. Typically, the diglycidyl ether bisphenol-A (DGEBA) epoxy resin is liquid at 25° C. and has an epoxy equivalent weight (EEW) within the range of from 175 to 300 g/eq, for example from 175 to 200 g/eq.

The curing agent component comprises a mixture of a first amine curing agent and a second amine curing agent. In this specification, the properties of the first and second amine curing agents are relevant to the present invention, although the curing agent component may comprise at least one additional amine curing agent. Typically, the curing agent component is present in the curable epoxy adhesive in a concentration of from 20 to 50 parts by weight curing agent component to 100 parts by weight epoxy resin component to provide the total weight of the curable epoxy adhesive. The curing agent component and/or the epoxy resin component may comprise additional ingredients, such as fillers, diluents, etc. Too low an amount of the curing agent component may cause a reduced cure of the epoxy resin material, whereas too high an amount may cause an excessively exothermic cure, reduced Tg and reduced mechanical properties.

The present invention is based upon the finding by the present inventors that by providing a specific mixture of specific first and second amine curing agents, a first amine curing agent which provides an “extra-long” working time can be used which on its own would also provide an “extra-long” cure time, and the cure time can be significantly shortened, without compromising or significantly reducing the “extra-long” working time, by mixing, together with the first amine curing agent, a second amine curing agent which on its own (a) is less latent at ambient temperature than the first amine curing agent and (b) is more exothermic during curing than the first amine curing agent.

The higher exothermic curing of the second amine curing agent raises the temperature of the curing resin as compared to the use of the first amine curing agent alone, and the increased temperature accelerates the curing of the resin by the curing agent mixture. However, although the second amine curing agent is less latent at ambient temperature than the first amine curing agent, the working time of the resin comprising the curing agent mixture is not excessively reduced by addition of the second amine curing agent, and an “extra-slow” hardener is achieved.

In other words, by providing a mixture of the first and second amine curing agents having a specific relationship between their individual properties, in particular the functional curing property of each of the respective first and second amine curing agents with respect to the epoxy resin component, the overall functional curing property of the epoxy resin component in the adhesive can be modified, and the desired “extra-slow” hardener can be achieved.

Such modification can provide improved epoxy resin adhesives because by providing a mixture of the specific first and second amine curing agents, the resultant amine-cured epoxy systems does not adopt a curing profile close to a first order kinetics model, whereby both the working time and the cure time tend to increase or decrease together in a linear relationship with any change in temperature.

In contrast, the epoxy resin adhesives formulated according to the present invention can independently increase the working time without significantly increasing the cure time, for any given curing temperature, as compared to an adhesive comprising only one curing agent, or a blend of curing agents that provides a curing profile close to a first order kinetics model.

In practical terms, for example, an adhesive that is suitable for manufacturing wind turbine blades and comprises a known amine curing agent system, for example the Applicant's known adhesive having an “Extra-slow” hardener as described above, can be modified, by use of the curing agent mixture of the first and second curing agents, to increase the “Extra-slow” working time and additionally reduce the cure time, for example reduce the cure time from 5 hours to 2 hours using a curing temperature of 70° C.

In accordance with the present invention, the functional curing property of each of the respective first and second amine curing agents with respect to the epoxy resin component, is important to achieve the resultant overall functional curing property of the epoxy resin component by the mixture of the first and second amine curing agents.

As is well known to those skilled in the art, the reactivity of an amine curing agent used for curing epoxy resins, and the final properties of the cured polymer, can be made to vary significantly depending on the number, type, and position of the reactive —NHₓ groups within the amine curing agent In particular, the degree of electronic effects, such as electron delocalisation, and steric hindrance can affect the reactivity of an amine curing agent.

In accordance with preferred embodiments of the present invention, the first amine curing agent may be considered to be a “base” amine curing agent which, when used alone, can provide “Extra-slow” working time and final properties of the cured polymer resin. Additional curing agents may be used in addition to the first curing agent to provide a “base” amine curing agent blend which, when used, can provide the desired working time and final properties of the cured polymer resin.

In contrast, the second amine curing agent may be considered to be a “modifier” amine curing agent which, when mixed with the first amine curing agent to substitute for a portion of the first amine curing agent, provides a combined amine curing agent system which does not shorten the working time, but does shorten the cure time, of the epoxy resin adhesive comprising only the “base” amine curing agent. Alternatively, the cure time may be unchanged, and the working time is lengthened.

The first amine curing agent comprises or consists of a polyoxyalkylene diamine having the formula NH₂—(Z)x-R—NH₂ where R is an aliphatic or cycloaliphatic constituent, which is either unsubstituted or substituted with at least one functional group, Z is an oxyalkylene moiety and x has a value of greater than 1 and less than 10.

Typically, in the first amine curing agent which comprises the polyoxyalkylene diamine having the formula NH₂—(Z)x-R—NH₂, Z is an oxypropylene moiety, and/or x has a value within the range of from 2 to 5, and/or R is an alkyl moiety having from 2 to 5 carbon atoms.

Preferably, in the first amine curing agent which comprises the polyoxyalkylene diamine having the formula NH₂—(Z)x-R—NH₂, Z is an oxypropylene moiety, x has a value within the range of from 2 to 3, and R is a propyl moiety having 3 carbon atoms. In a preferred embodiment, the polyoxyalkylene diamine having the formula NH₂—(Z)x-R—NH₂ has a number average molecular weight Mn of from 175 to 300, for example about 230.

A preferred first amine curing agent is available in commerce from Huntsman Advanced Materials under the trade name Jeffamine® D-230. This known amine curing agent is a difunctional primary amine, in particular a polyoxypropylenediamine having the formula:

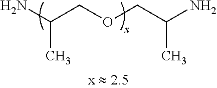

which has a number average molecular weight Mn of about 230. This polyoxypropylenediamine has an active hydrogen equivalent weight (AHEW) of 60 g/eq.

However, the second amine curing agent is required to be latent at ambient temperature but have a high peak exothermic temperature during curing. Consequently, the second amine curing agent is a diamine which has the formula NH₂—R¹—NH₂ where R¹ is any aromatic constituent, which is either unsubstituted or substituted with at least one functional group.

In preferred embodiments of the present invention, the second amine curing agent comprises a di(aminoalkyl) benzene, wherein each alkyl group has from 1 to 3 carbon atoms and the alkyl groups are the same or different in each aminoalkyl functional group. For example, in some preferred embodiments of the present invention the second amine curing agent comprises xylylenediamine, such as 1,3-Bis(aminomethyl)benzene (m-xylylenediamine) or 1,4-Bis(aminomethyl)benzene (p-xylylenediamine), a di(aminoethyl) benzene such as 1,3-Bis(aminoethyl)benzene or 1,4-Bis(aminoethyl)benzene, or a di(aminopropyl) benzene such as 1,3-Bis(aminopropyl)benzene or 1,4-Bis(aminopropyl)benzene, or any mixture of two or more thereof.

Typically, the second amine curing agent consists of one or more di(aminoalkyl) benzenes.

The second amine curing agent preferably comprises xylylenediamine, such as 1,3-Bis(aminomethyl)benzene (m-xylylenediamine) or 1,4-Bis(aminomethyl)benzene (p-xylylenediamine), A particularly preferred second amine curing agent is 1,3-Bis(aminomethyl)benzene (m-xylylenediamine) which is widely available in commerce under CAS Number 1477-55-0. This amine curing agent is also called m-XDA, or sometimes MXDA.

In preferred embodiments of the present invention, the curing agent component comprises or consists of the polyoxyalkylene diamine having the formula NH₂—(Z)x-R—NH₂, in which Z is an oxypropylene moiety, x has a value within the range of from 2 to 5, and R is an alkyl moiety having from 2 to 5 carbon atoms, as the first amine curing agent, and 1,3-Bis(aminomethyl)benzene (m-xylylenediamine) and/or 1,4-Bis(aminomethyl)benzene (p-xylylenediamine), as the second amine curing agent.

In some preferred embodiments of the present invention, the first amine curing agent, or the blend of the first amine curing agent and any additional amine curing agent to form a “base” amine curing agent blend, has a first amine functionality corresponding to an active hydrogen equivalent weight (AHEW) of from 50-75 and the second amine curing agent has a second amine functionality which corresponds to an active hydrogen equivalent weight (AHEW) of from 15-45. As is known to those skilled in the art, AHEW=amines (Active Hydrogen Equivalent Weight)=molecular weight/number of amine reactive sites e.g. NH=1, NH2=2, NR=0.

The curing agent component comprises from greater than 50 to up to 85 wt % of the first amine curing agent and from 15 to less than 50 wt % of the second amine curing agent, each based on the total weight of the first and second amine curing agents. Typically, the curing agent component comprises from 60 to 75 wt % of the first amine curing agent and from 25 to 40 wt % of the second amine curing agent, each based on the total weight of the first and second curing agents. As explained above, the curing agent components typically comprises additional ingredients in addition to the first and second amine curing agents.

Typically, the weight ratio of the first amine curing agent to the second amine curing agent is within the range of from 1.8:1 to 2.4:1, for example from 2.0:1 to 2.3:1.

Typically, the curing agent component comprises from 5 to 8 wt % of the first amine curing agent and from 2 to 4 wt % of the second amine curing agent, each based on the total weight of the curing agent component. In some preferred embodiments, the curing agent component comprises from 6 to 7 wt % of the first amine curing agent and from 2.5 to 3.5 wt % of the second amine curing agent, each based on the total weight of the curing agent component.

Typically, the curable epoxy resin adhesive, which comprises both the epoxy resin component and the curing agent component, comprises from 6.4 to 6.8 wt % of the first amine curing agent and from 2.9 to 3.3 wt % of the second amine curing agent, each based on the total weight of the curable epoxy resin adhesive.

In accordance with the present invention, the first and second amine curing agents each has a respective gel time and a respective peak exotherm temperature determined by mixing the first amine curing agent alone with a test epoxy resin component to form a respective first or second curable mixture.

The test epoxy resin is one epoxide-containing resin of the epoxy resin component that is present in a concentration of more than 50 wt % of the at least one epoxide-containing resin. Preferably, the test epoxy resin is a diglycidyl ether bisphenol-A (DGEBA) epoxy resin. Preferably, the test epoxy resin is liquid at 25° C. Preferably, the test epoxy resin has an epoxy equivalent weight (EEW) within the range of from 175 to 200, and is optionally about 187.

The first amine curing agent has a first gel time G1 when a 150 g sample of the first curable mixture is at an ambient temperature of 25° C. and a first peak exotherm temperature T1 when a 10 mL sample of the first curable mixture is cured in air at a curing temperature of 70° C. In contrast, the second curing agent has a second gel time and a second peak exotherm temperature determined by mixing the second amine curing agent alone with the test epoxy resin to form a second curable mixture. The second amine curing agent has a second gel time G2 when a 150 g sample of the second curable mixture is at an ambient temperature of 25° C. and a second peak exotherm temperature T2 when a 10 mL sample of the second curable mixture is cured in air at a curing temperature of 70° C.

In accordance with preferred embodiments of the present invention, a ratio G1:G2 between the first and second gel times is from 2-4:1 and the second peak exotherm temperature T2 is higher than the first peak exotherm temperature T1 by a temperature Δt, wherein Δt is at least 25° C., optionally at least 50° C.

Typically, Δt is from 25 to 75° C., optionally from 50 to 75° C. In some preferred embodiments of the present invention, the first peak exotherm temperature T1 is within the range of from 160 to 190° C. and/or the second peak exotherm temperature T2 is within the range of from 225 to 255° C. For example, the first peak exotherm temperature T1 is within the range of from 170 to 180° C. and/or the second peak exotherm temperature T2 is within the range of from 230 to 250° C.

The ratio G1:G2 between the first and second gel times means that the first curing agent is significantly more latent at ambient temperature than the second amine curing agent. Nevertheless, the second curing agent does not decrease, the working time at ambient temperature, i.e. 25° C., and the working time at even higher working temperatures, such as 40° C., that are typically encountered during commercial use, as compared to when only the first amine curing agent is used.

Typically, the first gel time G1 is from 500 to 700 minutes and the second gel time G2 is from 100 to 300 minutes; for example the first gel time G1 is from 550 to 650 minutes and the second gel time G2 is from 150 to 250 minutes.

The addition of the second curing agent resulted in a higher peak exotherm temperature, and a shorter curing time, as compared to the composition comprising only the first curing agent.

The peak exotherm temperature, and the increase in peak exotherm temperature, are measurable parameters of curable resins that are directly related to the reactivity of the amine curing agent system with the epoxy resin component that is being cured.

The positive temperature difference Δt between the respective peak exotherm temperatures of the second and first amine curing agents means that the second curing agent is more exothermic, optionally significantly more exothermic, during curing at the curing temperature than the first amine curing agent. This in turns provides that the second curing agent decreases the cure time at the elevated (compared to ambient temperature) curing temperature as compared to when only the first amine curing agent is used.

The curing by the second curing agent can progressively generate exothermic heat which accelerates the curing action of the first curing agent, and the combined technical effect is that the cure time of the curable epoxy adhesive is reduced.

In some preferred embodiments of the present invention, the curing agent component, i.e. the mixture of the first and second amine curing agents, has a peak exotherm temperature of from 200 to 230° C., optionally from 210 to 220° C., when a 10 mL sample of the third curable mixture is at a curing temperature of 70° C.

In some preferred embodiments of the present invention, the curing agent component provides a time period (P1) from initiation of curing to peak exotherm temperature for the combined amine curing agent which is from 1000 to 1500 seconds, optionally from 1200 to 1350 seconds, measured when the curing is carried out in air at a curing temperature of 70° C. and on a resin sample having a volume of 10 mL. Additionally or alternatively, the curing agent component provides a time period (P2) from initiation of curing to peak exotherm temperature for the combined amine curing agent which is from 7000 to 9000 seconds, optionally from 7500 to 8500 seconds, measured when the curing is carried out in air at a curing temperature of 40° C. and on a resin sample having a volume of 10 mL.

The cured adhesive can have a high Tg2, and therefore has high mechanical properties associated with a high degree of curing and crosslinking.

It has been found by the present inventors that the addition of the second amine curing agent can provide a high Tg2 to the cured epoxy resin even though the working time can be relatively long. The addition of the second amine curing agent to the first amine curing agent can provide a shorter cure time without any decease in working time and without any significant decrease in the Tg2 of the cured epoxy resin. In other words, the addition of the second amine curing agent can shorten cure time without any detriment to the mechanical properties of the cured resin.

When the first amine curing agent is a polyoxyalkylene diamine and the second amine curing agent is an aromatic diamine, the combination of the first and second amine curing agents can provide a short cure time and a long working time when the working time is measured at a higher-than-ambient working temperature of typically 40° C. In other words, the selection of the combination of a polyoxyalkylene diamine as the first amine curing agent and an aromatic diamine as the second amine curing agent permits a higher working temperature to be used without any significant reduction in the working time or increase in the cured time. Also, the selection of such a combination of amine curing agents permits a high peak exotherm temperature, and a high Tg2 associated with good mechanical properties, to be achieved.

In some embodiments of the present invention, the epoxy resin adhesive may further comprise an accelerator, which may be formulated so that the epoxy resin may be cured at a selected curing temperature and/or to modify the Tg2 of the cured resin. Any known accelerator may optionally be added to the adhesive, as known to those skilled in the art.

The curable epoxy resin adhesive may further comprise any other known additives, such as a rheology modifier, as known to those skilled in the art. The rheology modifier may typically comprise at least one of a thermoplastic resin and an inorganic particulate thickener or a mixture thereof. Inorganic fillers such as calcium carbonate, fumed silica, wetting additives, air release additives, coupling agents, etc may additionally or alternatively be present in any combination as is well known to those skilled in the art of epoxy resin adhesives.

The present invention further provides a method of manufacturing a curable epoxy resin adhesive. The method comprises the steps of.
i. providing the epoxy resin component, which comprises at least one epoxide-containing resin, as described above;
ii. providing a first amine curing agent, as described above;
iii. providing a second amine curing agent, as described above;
iv. mixing together the first and second amine curing agents to produce a curing agent component, wherein the curing agent component comprises from greater than 55 to up to 85 wt % of the first amine curing agent and from 15 to less than 50 wt % of the second amine curing agent, each based on the total weight of the first and second amine curing agents; and
v. providing both the epoxy resin component and the curing agent component in a separated form thereby to provide the curable epoxy resin adhesive, wherein providing a mixture of the epoxy resin component and the curing agent component at a curing temperature of the adhesive causes curing of the epoxy resin component by the curing agent component.

The present invention further provides a use of the curable epoxy resin adhesive according to the present invention, or produced by the method according to the present invention, for bonding together structural parts of a wind turbine blade, a marine vessel or a civil engineering structure.

The preferred embodiments of the present invention will now be described further with reference to the following non-limiting Examples.

### Example 1 and Comparative Example 1

A first amine curing agent, called Curing agent #1, was provided. The first curing agent is available in commerce from Huntsman Advanced Materials under the trade name Jeffamine® D-230. This known amine curing agent is a difunctional primary amine, in particular a polyoxypropylenediamine. The first curing agent had an AHEW of 60 g/eq.

A second amine curing agent, called Curing agent #2, was also provided. The second amine curing agent is 1,3-Bis(aminomethyl)benzene (m-xylylenediamine) which is widely available in commerce under CAS Number 1477-55-0. This amine curing agent is also called m-XDA, or sometimes MXDA. The second curing agent had an AHEW of 34 g/eq.

A mixture, called Blend E, of the first and second amine curing agents was formulated, and the weight ratios in the mixture are shown in Table 1 below. Blend E is in accordance with Example 1.

TABLE 1

| | Example 1 |
|---|---|
| | Blend E |
| Curing agent #1 - Jeffamine ® D230 | 68.2 wt % |
| Curing agent #2 - MXDA | 31.8 wt % |

The properties of the individual Curing agents #1 and #2, and of the Blend E comprising a mixture of the individual Curing agents #1 and #2, were then measured. In particular, a single epoxy resin, to be used for an epoxy resin adhesive composition, was provided.

In order to simulate actual applications during use of the adhesive, and to determine the absolute and relative working and curing properties of the first and second amine curing agents, the first and second curing agents were tested in a modelled epoxy resin system. The modelled epoxy resin system comprised a test hardener, including the curing agent(s) to be tested, and a test epoxy resin, including at least one epoxy resin that is to be used in the final epoxy resin adhesive composition. The use of such a modelled epoxy resin system comprising a test hardener and a test epoxy resin enables reliable and repeatable test results to be readily achieved in order to be able to determine the absolute and relative curing properties of the first and second amine curing agents. The modelled epoxy resin system is a simplified version of the adhesive formulation, without addition of fillers or other additives, and the working and curing behaviour of the modelled epoxy resin system represents the working and curing behaviour of the final adhesive formulation.

In the modelled epoxy resin system the test hardener consisted of the amine(s) to be tested and the test epoxy resin consisted of a single epoxy resin, in particular a diglycidyl ether bisphenol-A (DGEBA) epoxy resin which is liquid at 25° C., that is to be comprised in the final curable epoxy resin adhesive as a primary epoxy resin ingredient, i.e. the test epoxy resin comprises greater than 50 wt % of the at least one epoxy resin(s) in the epoxy resin component of the of the final adhesive formulation.

For all of the measurements which used the modelled epoxy resin system, the epoxy resin component used was a diglycidyl ether bisphenol-A (DGEBA) liquid epoxy resin with an Epoxy Equivalent Weight (EEW) of 187 (g/eq). The epoxy resin was mixed with either the single amines or amine blends as described above to provide a total weight of curable resin of 150 g.

Each of the individual Curing agents #1 and #2, and Blend E of the individual Curing agents #1 and #2, were respectively mixed with the test epoxy resin at a weight ratio to provide a full curing reaction between the amine reactive groups in the curing agent and the epoxide groups in the test epoxy resin.

The enthalpy of reaction was investigated for individual Curing agents #1 and #2, and of the Blend E.

When an epoxy resin adhesive composition is cured over a large surface area, for example during manufacture of a wind turbine blade, the large bond area provides a thermal system during curing which is pseudo-adiabatic (i.e. the resin being cured does not gain or lose significant thermal energy to the bonded parts or environment during curing) due to the relatively large bond areas.

In the present specification, the curing time of the modelled epoxy resin system was tested using specific curing parameters on a specific volume of the test epoxy resin, as described hereinabove, in order to achieve a reliable and repeatable test protocol. This specific test was employed to measure the following parameters in the modelled epoxy resin system for the first and second amine curing agents, individually and in combination: peak exotherm temperature during curing, and time period from initiation of curing to peak exotherm temperature during curing.

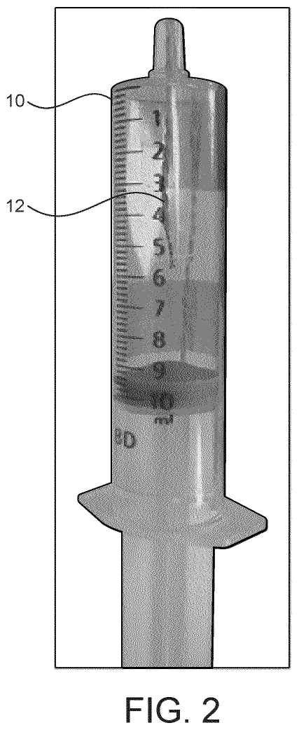

The modelled epoxy resin system used the following method for recording the peak exotherm temperature during curing and the time period from initiation of curing to peak exotherm temperature during curing:
1. The test epoxy resin and test hardener comprising the amine(s) to be tested are mixed/blended using a mixing machine having preset mixing time and mixing speed which are used for all tests and ensure complete mixing of the ingredients.
2. 10 mL of the mixed blend are then drawn into a conventional polymeric syringe (10) having an inner diameter of 14.5 mm and a volume scale marked along the length of the syringe, as shown in FIG. 2.
3. As shown in FIG. 2, a thermocouple wire (12) is introduced into the outlet aperture of the syringe to record temperature at the 5 mL marking on the volume scale in order to record the temperature at the centre of the volume of the liquid.
4. The syringe is introduced into an oven set at 70° C., and the air temperature of the oven is monitored during the length of the test protocol using conventional temperature measurement software (for example from Pico™)
5. The temperature measurement software is used to record the time and temperature of the exothermic curing reaction within the syringe.

This test protocol was used to test 10 mL samples, provided in a respective syringe, of each tested curable epoxy resin adhesive comprising individual Curing agents #1 and #2, and Blend E, which were reactively cured in air and within an oven at an applied elevated curing temperature of 70° C., and the resulting increase in temperature and associated time, were recorded. The value of the peak exotherm temperature, and time taken to reach the peak exotherm temperature, was measured using this protocol, i.e. by curing in air at 70° C. a 10 mL sample, in a syringe, of the curable epoxy resin adhesive composition.

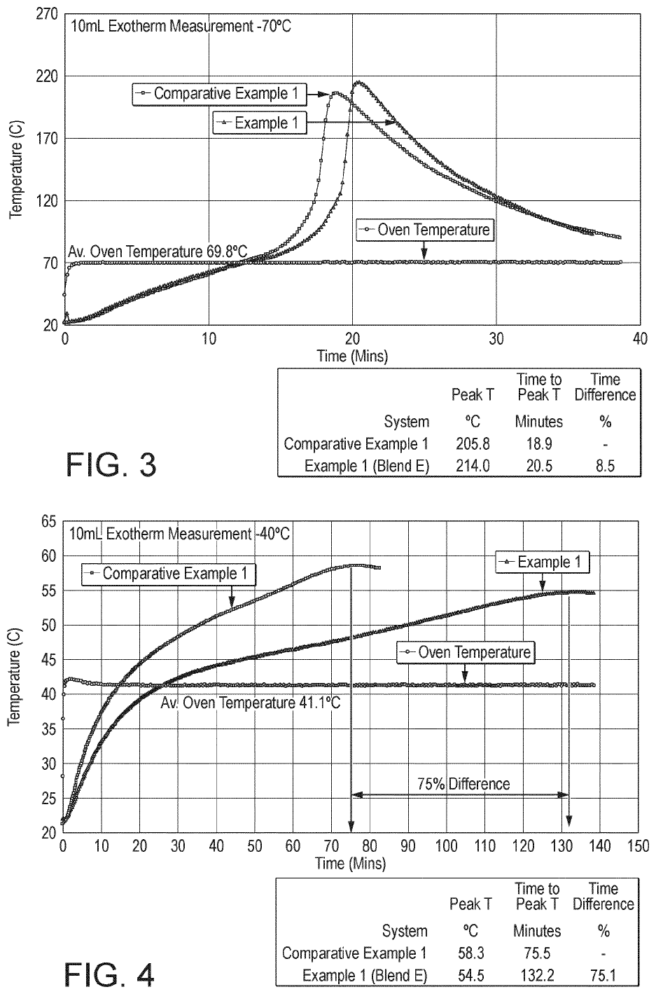

The results are shown in FIG. 3 which shows the relationship between temperature and time during curing for Blend E at an applied elevated curing temperature of approximately 70° C. (more accurately, 69.8° C.). The peak exotherm temperature and the time period to reach the peak exotherm temperature are also listed in Table 2.

TABLE 2

| Curing temperature - | Peak Exotherm | Time To Peak Exotherm |
|---|---|---|
| 70° C. | Temperature (° C.) | Temperature (seconds) |
| Curing Agent #1 | 175.03 | 1814 |
| JEFFAMINE ® D230 | | |
| Curing Agent #2 | 238.71 | 940 |
| m-xylylenediamine | | |
| Blend E | 214.04 | 1230 |
| Comparative Example 1 | 205.8 | 1134 |

The test protocol was repeated on a 10 mL sample, provided in a syringe, of the curable epoxy resin adhesive comprising Blend E, which was reactively cured in air and within an oven at a lower applied elevated curing temperature of about 40° C. (more accurately, 41.1° C.), and the resulting increase in temperature and associated time, were recorded, in order to determine the peak exotherm temperature and the time to peak exotherm temperature. This lower applied elevated curing temperature of about 40° C. represents a working temperature of 40° C. and the time to peak exotherm temperature represents a working time at that temperature.

The results are shown in FIG. 4 which shows the relationship between temperature and time during curing for Blend E at an applied elevated curing temperature of about 40° C. The peak exotherm temperature and the time period to reach the peak exotherm temperature are also listed in Table 3.

TABLE 3

| Curing temperature - | Peak Exotherm | Time To Peak Exotherm |
|---|---|---|
| 40° C. | Temperature (° C.) | Temperature (seconds) |
| Blend E | 54.49 | 7930 |
| Comparative Example 1 | 58.3 | 4530 |

Comparative Example 1 used the liquid amine components from a sample of a known epoxy resin adhesive which is sold by the Applicant under the trade-name Spabond SP800 and is formulated to have an “Extra-slow” hardener.

Two 10 mL samples of the known adhesive of Comparative Example 1 were subjected to the same test protocol at curing temperatures of, respectively, 70° C. and 40° C., and the results are shown in Table 2/FIG. 3 for the curing temperature of 70° C. and 40° C. and Table 3/FIG. 4 for the curing temperature of 40° C.

It may be seen from Table 2/FIG. 3 that when the adhesive of Example 1 is cured at 70° C., the peak exotherm temperature is slightly lower than for the adhesive of Comparative Example 1. Since the adhesive reactivity is proportional to temperature, the lower temperature to which the curable resin of Example 1 is exposed during cure will result in a slightly lower cure rate and/or slightly lower Tg of the resultant cured epoxy resin. The fact that the peak exothermic is only slightly lower means that the Tg of the cured resin would be only slightly lower too which in turn means that the mechanical properties are of the cured resin of Example 1 would be substantially the same as those of the known resin of Comparative Example 1. Also, the time to reach the peak exotherm temperature for the adhesive of Example 1 is longer, by about 8.4%, than the corresponding time for the adhesive of Comparative Example 1.

However, it may also be seen from Table 3/FIG. 4 that when the adhesive of Example 1 is cured at 40° C., which represents a working temperature of the resin prior to curing during use, the peak exotherm temperature is significantly lower than for the adhesive of Comparative Example 1. Moreover, and importantly, the time to reach the peak exotherm temperature for the adhesive of Example 1 is significantly longer, by about 75.10%, than the corresponding time for the adhesive of Comparative Example 1. This means that the adhesive of Example 1 can provide a significantly longer “Extra-slow” working time than the adhesive of Comparative Example 1.

In summary, by using the hardener system in accordance with the present invention, the working time of an “Extra-slow” hardener for an epoxy resin adhesive can be significantly increased as compared to a known adhesive having an “Extra-slow” hardener of Comparative Example 1. This significant increase in working time, e.g. an increase of about 75%, is slightly offset by a smaller increase in curing time, e.g. an increase of about 8.4%, but nevertheless the increase in working time provide an overall significant advantage for many applications where a long working time is required. Also, the increase in working time is not compromise by any significant decrease in mechanical properties in the cured resin. In fact, the mechanical properties can be maintained despite the improvement in working time.

Furthermore, the TECAM geltime at a temperature of 25° C. for each curable epoxy resin/amine curing agent adhesive mixture was measured. The geltime is representative of the working time of the resin at ambient temperature.

The testing protocol was as follows: 150 g of the epoxy resin/amine curing agent adhesive mixture in an open-topped container was placed within a 25° C. (+/−0.2° C.) waterbath.

A commercially available Gelation Timer, available in commerce from Techne under the trade name Techne® FGT6, was then used to determine the point at which the mixed system reaches gelation point. A buoyant plunger is suspended in the heated resin from a driven mechanism imparting simple harmonic motion of fixed amplitude in a vertical plane and coupled so that the plunger is positively raised during the upstroke, but is free to fall at a rate not faster than the simple harmonic motion on the down stroke. The gelation time is measured as the period between completion of the addition of all appropriate curing agents to the resin system and the automatic detection of the movement when gelation of the resin becomes sufficient for the mixture just to support the plunger. The standard protocol of the Techne® FGT6 Gelation Timer was used which provides an accuracy of the gelation time, i.e. the “geltime”, to within +/2%.

The results are shown in Table 4 which shows that Curing Agent #1 exhibited a long geltime of 598 minutes, whereas Curing Agent #2 exhibited a shorter geltime of 157 minutes. The geltime of Blend E, at 347.2 minutes, is between the geltimes of Curing Agents #1 and #2. The geltime of Blend E indicates a long working time, consistent with an “Extra-slow” hardener.

TABLE 4

| | Geltime @ 25° C. (minutes) |
|---|---|
| Curing Agent #1 JEFFAMINE D230 | 598 |
| Curing Agent #2 MXDA | 157 |
| Blend E | 347.2 |

Various modifications to the preferred embodiments of the present invention, as defined in the appended claims, will be apparent to those skilled in the art.

1. A curable epoxy resin adhesive, the adhesive comprising an epoxy resin component and a curing agent component, wherein the epoxy resin component and the curing agent component are in a separated form, and wherein providing a mixture of the epoxy resin component and the curing agent component at a curing temperature of the adhesive causes curing of the epoxy resin component by the curing agent component,
wherein the epoxy resin component comprises at least one epoxide-containing resin, and
wherein the curing agent component comprises:
(i) a first amine curing agent, wherein the first amine curing agent comprises a polyoxyalkylene diamine having the formula NH₂—(Z)x-R—NH₂ where R is an aliphatic or cycloaliphatic constituent, which is either unsubstituted or substituted with at least one functional group, Z is an oxyalkylene moiety and x has a value of greater than 1 and less than 10; and
(ii) a second amine curing agent having the formula NH₂—R¹—NH₂ where R¹ is any aromatic constituent, which is either unsubstituted or substituted with at least one functional group,
wherein the curing agent component comprises from greater than 50 to up to 85 wt % of the first amine curing agent and from 15 to less than 50 wt % of the second amine curing agent, each based on the total weight of the first and second amine curing agents.

2. A curable epoxy resin adhesive according to claim 1 wherein the first amine curing agent has a first amine functionality corresponding to an active hydrogen equivalent weight (AHEW) of from 50-75 and the second amine curing agent has a second amine functionality which corresponds to an active hydrogen equivalent weight (AHEW) of from 15-45.

3. A curable epoxy resin adhesive according to claim 1 wherein in the first amine curing agent which comprises the polyoxyalkylene diamine having the formula NH₂—(Z)x-R—NH₂, Z is an oxypropylene moiety.

4. A curable epoxy resin adhesive according to claim 1 wherein in the first amine curing agent which comprises the polyoxyalkylene diamine having the formula NH₂—(Z)x-R—NH₂, x has a value within the range of from 2 to 5.

5. A curable epoxy resin adhesive according to claim 1 wherein in the first amine curing agent which comprises the polyoxyalkylene diamine having the formula NH₂—(Z)x-R—NH₂, R is an alkyl moiety having from 2 to 5 carbon atoms.

6. A curable epoxy resin adhesive according to claim 1 wherein in the first amine curing agent which comprises the polyoxyalkylene diamine having the formula NH₂—(Z)x-R—NH₂, Z is an oxypropylene moiety, x has a value within the range of from 2 to 3, and R is a propyl moiety having 3 carbon atoms.

7. A curable epoxy resin adhesive according to claim 1 wherein the polyoxyalkylene diamine having the formula NH₂—(Z)x-R—NH₂ has a number average molecular weight Mn of from 175 to 300.

8. A curable epoxy resin adhesive according to claim 7 wherein the polyoxyalkylene diamine having the formula NH₂—(Z)x-R—NH₂ has a number average molecular weight Mn of about 230.

9. A curable epoxy resin adhesive according to claim 1 wherein the first amine curing agent consists of the polyoxyalkylene diamine having the formula NH₂—(Z)x-R—NH₂.

10. A curable epoxy resin adhesive according to claim 1 wherein the second amine curing agent comprises di(aminoalkyl) benzene, wherein each alkyl group has from 1 to 3 carbon atoms and the alkyl groups are the same or different in each aminoalkyl functional group.

11. A curable epoxy resin adhesive according to claim 1 wherein the second amine curing agent comprises xylylenediamine, such as 1,3-Bis(aminomethyl)benzene (m-xylylenediamine) or 1,4-Bis(aminomethyl)benzene (p-xylylenediamine), 1,3-Bis(aminoethyl)benzene, 1,4-Bis(aminoethyl)benzene, 1,3-Bis(aminopropyl)benzene or 1,4-Bis(aminopropyl)benzene, or any mixture of two or more thereof.

12. A curable epoxy resin adhesive according to claim 10 wherein the second amine curing agent consists of one or more di(aminoalkyl) benzenes.

13. A curable epoxy resin adhesive according to claim 10 wherein the curing agent component comprises or consists of the polyoxyalkylene diamine having the formula NH₂—(Z)x-R—NH₂, in which Z is an oxypropylene moiety, x has a value within the range of from 2 to 5, and R is an alkyl moiety having from 2 to 5 carbon atoms, as the first amine curing agent, and 1,3-Bis(aminomethyl)benzene (m-xylylenediamine) and/or 1,4-Bis(aminomethyl)benzene (p-xylylenediamine), as the second amine curing agent.

14. A curable epoxy resin adhesive according to claim 1 wherein the curing agent component comprises from 60 to 75 wt % of the first amine curing agent and from 25 to 40 wt % of the second amine curing agent, each based on the total weight of the first and second curing agents.

15. A curable epoxy resin adhesive according to claim 1 wherein the curable epoxy resin adhesive exhibits a peak exotherm temperature within the range of from 200 to 230° C., when a 10 mL sample of the curable epoxy resin adhesive is cured in air at a curing temperature of 70° C.

16. A curable epoxy resin adhesive according to claim 15 wherein the curable epoxy resin adhesive exhibits a peak exotherm temperature within the range of from 210 to 220° C., when a 10 mL sample of the curable epoxy resin adhesive is cured in air at a curing temperature of 70° C.

17. A curable epoxy resin adhesive according to claim 1 wherein the curable epoxy resin adhesive exhibits a time period P1 from initiation of curing to peak exotherm temperature of from 1000 to 1500 seconds, measured when the curing is carried out in air at a curing temperature of 70° C. and on a resin sample having a volume of 10 mL.

18. A curable epoxy resin adhesive according to claim 17 wherein the curable epoxy resin adhesive exhibits a time period P1 from initiation of curing to peak exotherm temperature of from 1200 to 1350 seconds, measured when the curing is carried out in air at a curing temperature of 70° C. and on a resin sample having a volume of 10 mL.

19. A curable epoxy resin adhesive according to claim 1 wherein the curable epoxy resin adhesive exhibits a time period P2 from initiation of curing to peak exotherm temperature of from 7000 to 9000 seconds, measured when the curing is carried out in air at a curing temperature of 40° C. and on a resin sample having a volume of 10 mL.

20. A curable epoxy resin adhesive according to claim 19 wherein the curable epoxy resin adhesive exhibits a time period P2 from initiation of curing to peak exotherm temperature of from 7500 to 8500 seconds, measured when the curing is carried out in air at a curing temperature of 40° C. and on a resin sample having a volume of 10 mL.

21. A curable epoxy resin adhesive according to claim 1 wherein the weight ratio of the first amine curing agent to the second amine curing agent is within the range of from 1.8:1 to 2.4:1.

22. A curable epoxy resin adhesive according to claim 21 wherein the weight ratio of the first amine curing agent to the second amine curing agent is within the range of from 2.0:1 to 2.3:1.

23. A curable epoxy resin adhesive according to claim 1 wherein the curing agent component comprises from 5 to 8 wt % of the first amine curing agent and from 2 to 4 wt % of the second amine curing agent, each based on the total weight of the curing agent component.

24. A curable epoxy resin adhesive according to claim 23 wherein the curing agent component comprises from 6 to 7 wt % of the first amine curing agent and from 2.5 to 3.5 wt % of the second amine curing agent, each based on the total weight of the curing agent component.

25. A curable epoxy resin adhesive according to claim 1 wherein the curable epoxy resin adhesive, which comprises both the epoxy resin component and the curing agent component, comprises from 6.4 to 6.8 wt % of the first amine curing agent and from 2.9 to 3.3 wt % of the second amine curing agent, each based on the total weight of the curable epoxy resin adhesive.

26. A curable epoxy resin adhesive according to claim 1 wherein the epoxy resin component comprises a diglycidyl ether bisphenol-A (DGEBA) epoxy resin.

27. A curable epoxy resin adhesive according to claim 26 wherein the diglycidyl ether bisphenol-A (DGEBA) epoxy resin is liquid at 25° C. and has an epoxy equivalent weight (EEW) within the range of from 175 to 200 g/eq.

28. A method of manufacturing a curable epoxy resin adhesive according to claim 1, the method comprising the steps of:
i. providing the epoxy resin component;
ii. providing the first amine curing agent;
iii. providing the second amine curing agent;
iv. mixing together the first and second amine curing agents to produce the curing agent component; and
v. providing both the epoxy resin component and the curing agent component in a separated form thereby to provide the curable epoxy resin adhesive, wherein providing a mixture of the epoxy resin component and the curing agent component at a curing temperature of the adhesive causes curing of the epoxy resin component by the curing agent component.

29. Use of the curable epoxy resin adhesive according to claim 1 for bonding together structural parts of a wind turbine blade, a marine vessel or a civil engineering structure.
